(19) United States
(12) Patent Application Publication
(10) Pub. No.: US 2026/0124478 A1
(43) Pub. Date: May 7, 2026

(54) PASS THROUGH BUCKLE COVER KEEPER

(71) Applicant: WERNER CO., Itasca, IL (US)

(72) Inventor: Ivan D. Lopez, Dripping Springs, PA (US)

(21) Appl. No.: 19/380,476

(22) Filed: Nov. 5, 2025

Related U.S. Application Data
(60) Provisional application No. 63/717,348, filed on Nov. 7, 2024.

(51) Int. Cl. A62B 35/00; A44B 11/25

(52) U.S. Cl. CPC A62B 35/0025; A44B 11/2546

(57) ABSTRACT

A buckle cover keeper for a pass through buckle including a larger buckle and a smaller buckle structured to be releasably coupled together may include a cover keeper body having a shape corresponding to an outer perimeter of the larger buckle. The cover keeper body is structured to be coupled to the larger buckle. The buckle cover keeper may include at least one tab coupled to the cover keeper body and extending inwardly from the cover keeper body. The at least one tab is structured to create an area between the at least one tab and a top surface of the larger buckle when the cover keeper body is coupled to the larger buckle. The area is structured to receive an outer edge of the smaller buckle when the smaller buckle is coupled to the larger buckle.

### RELATED APPLICATIONS

This application claims priority to U.S. Provisional Application No. 63/717,348, filed November 7, 2024, the entire content of which is incorporated herein by reference.

### FIELD OF THE INVENTION

The disclosed concept relates generally to accessories for harnesses in fall protection systems, and in particular, to a pass through buckle cover keeper for use with a pass through buckle.

### BACKGROUND OF THE INVENTION

In fall protection systems, a worker typically wears a safety harness. At one or more connection points on the harness, one portion of webbing is releasably coupled to another portion of webbing on the harness. One of the most economical options for making such connections is a pass through buckle. A pass through buckle includes a larger buckle coupled to a first portion of the webbing and a smaller buckle coupled to a second portion of the webbing. The larger buckle includes an opening through which the smaller buckle can pass when the smaller buckle is rotated on a side with respect to the larger buckle. After passing the smaller buckle through the opening of the larger buckle, the smaller buckle is rotated so that it is flat with respect to the larger buckle. In this orientation, the smaller buckle cannot pass back through the opening of the larger buckle. In this orientation, the larger buckle and the smaller buckle are considered to be connected, and thus, the first and second portions of the webbing are connected via the pass through buckle. By rotating the smaller buckle on its side with respect to the larger buckle, the smaller buckle can then be passed back through the opening of the larger buckle to disconnect the smaller buckle from the larger buckle, and thus disconnect the first and second portions of webbing from each other.

However, the webbing of the harness can shift, pushing and pulling the first and second portions of webbing in various directions and angles. In some circumstances, the movement of the webbing can cause a connection between the larger and smaller buckles to become loose and in some cases disconnect. For example, the first and second portions of webbing being pushed toward each other can cause the smaller buckle to separate from the larger buckle and rotate on its side such that it can inadvertently be pulled back through the opening of the larger buckle and cause the smaller buckle to disconnect from the larger buckle.

There is room for improvement in connection points for harnesses.

### SUMMARY OF THE INVENTION

In accordance with an aspect of the disclosed concept, a buckle cover keeper for a pass through buckle including a larger buckle and a smaller buckle structured to be releasably coupled together includes: a cover keeper body having a shape corresponding to an outer perimeter of the larger buckle, the cover keeper body being structured to couple to the larger buckle; and at least one tab coupled to the cover keeper body and extending inwardly from the cover keeper body, wherein the at least one tab is structured to create an area between the at least one tab and a top surface of the larger buckle when the cover keeper body is coupled to the larger buckle, and wherein the area is structured to receive an outer edge of the smaller buckle when the smaller buckle is coupled to the larger buckle.

In accordance with an aspect of the disclosed concept, a safety harness includes: a first portion of webbing; a second portion of webbing; a pass through buckle including a larger buckle coupled to the first portion of webbing and a smaller buckle coupled to the second portion of webbing, wherein the larger buckle and the smaller buckle are structured to be releasably coupled together; and a buckle cover keeper including: a cover keeper body having a shape corresponding to an outer perimeter of the larger buckle, the cover keeper body being structured to couple to the larger buckle; and at least one tab coupled to the cover keeper body and extending inwardly from the cover keeper body, wherein the at least one tab is structured to create an area between the at least one tab and a top surface of the larger buckle when the cover keeper body is coupled to the larger buckle, and wherein the area is structured to receive an outer edge of the smaller buckle when the smaller buckle is coupled to the larger buckle.

In accordance with an aspect of the disclosed concept, a safety harness includes: a first portion of webbing; a second portion of webbing; a pass through buckle including a larger buckle coupled to the first portion of webbing and a smaller buckle coupled to the second portion of webbing, wherein the larger buckle and the smaller buckle are structured to be releasably coupled together; and a buckle cover keeper comprising a cover keeper body having a shape corresponding to an outer perimeter of the larger buckle, the cover keeper body having an upper surface and a lower surface defining a groove therebetween that receives the outer perimeter of the larger buckle; and at least one tab coupled to the cover keeper body and extending inwardly from the cover keeper body.

### BRIEF DESCRIPTION OF THE DRAWINGS

A full understanding of the invention can be gained from the following description of the preferred embodiments when read in conjunction with the accompanying drawings in which:

FIG. 1 is an image of a pass through buckle with a pass through buckle cover keeper in accordance with an example embodiment of the disclosed concept;

FIG. 2 is an image of the pass through buckle of FIG. 1 in the process of being connected in accordance with an example embodiment of the disclosed concept;

FIG. 3 is an image of the pass through buckle of FIG. 1 in the process of being connected in accordance with an example embodiment of the disclosed concept;

FIG. 4 is an image of the pass through buckle of FIG. 1 in the process of being secured with the pass through buckle cover keeper in accordance with an example embodiment of the disclosed concept;

FIG. 5 is an image of the pass through buckle of FIG. 1 secured with the pass through buckle cover keeper in accordance with an example embodiment of the disclosed concept;

FIG. 6 is an image of the pass through buckle of FIG. 1 secured with the pass through buckle cover keeper in accordance with an example embodiment of the disclosed concept;

FIG. 7 is an image of a buckle cover keeper and larger buckle in accordance with an example embodiment of the disclosed concept;

FIG. 8 is another image of a buckle cover keeper and larger buckle in accordance with an example embodiment of the disclosed concept; and

FIG. 9 is another image of a buckle cover keeper and larger buckle in accordance with an example embodiment of the disclosed concept.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

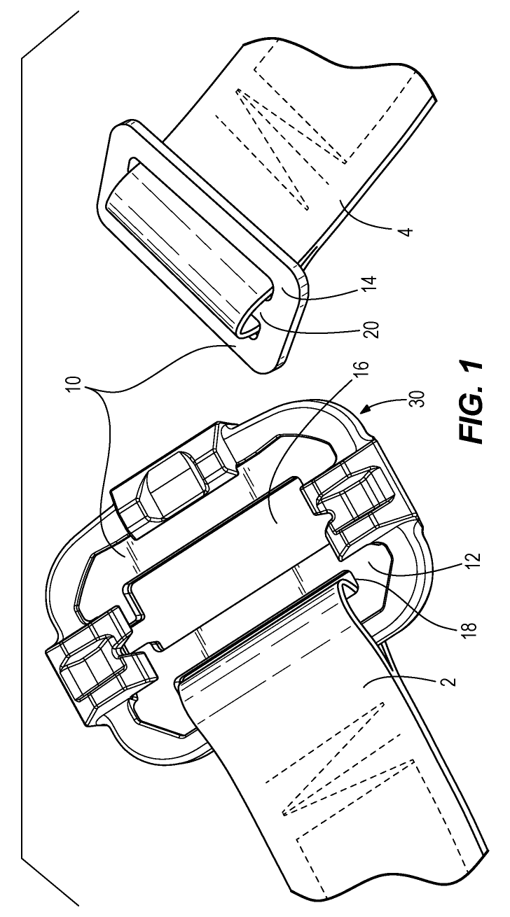

FIG. 1 is an image of a pass through buckle 10 with a pass through buckle cover keeper 30 in accordance with an example embodiment of the disclosed concept. A safety harness includes the pass through buckle 10, the pass through buckle cover keeper 30, a first portion of webbing 2 and a second portion of webbing 4. The pass through buckle 10 includes a first buckle 12 and a second buckle 14. The first buckle 12 is larger than the second buckle 14, and thus the first buckle 12 is referred to herein as the “larger buckle” and the second buckle 12 is referred to herein as the “smaller buckle.” The larger buckle 12 is a planar member having a substantially rectangular shape. An opening 16 is formed in the larger buckle 12. The opening 16 is formed in a central portion of the larger buckle 12 and may have an elongated rectangular shape. In some example embodiments, notches may extend from short sides of the opening 16. The larger buckle 12 further includes a larger buckle webbing connection point 18. The webbing connection point 18 is structured to couple the larger buckle 12 to a portion of webbing, such as the first portion of webbing 2 shown in FIG. 1. The webbing connection point 18 may be composed of a pair of slots. The webbing may be passed through the slots and then stitched back on itself to couple the webbing to the larger buckle 12.

The smaller buckle 14 is also a planar member having a substantially rectangular shape. The smaller buckle 14 includes a smaller buckle webbing connection point 20 structured to couple the smaller buckle 14 to a portion of webbing, such as the second portion of webbing 4 shown in FIG. 1. The webbing connection point 20 may be a pair of slots through which the webbing can pass and then be stitched back on itself to couple the smaller buckle 14 to the webbing. An area of the rectangular shape of the smaller buckle 14 is smaller than an area of the rectangular shape of the larger buckle 12.

The smaller buckle 14 and the opening 16 of the larger buckle 12 are respectively sized such that the smaller buckle 14 may pass through the opening 16 of the larger buckle 12 in a first orientation with respect to the larger buckle 12 and may not pass through the opening 16 in a second orientation with respect to the larger buckle 12. The first orientation may be an orientation in which the planar surface of the smaller buckle 14 is substantially angled with respect to the planar surface of the larger buckle 12 and the second orientation may be an orientation in which the planar surface of the smaller buckle 14 is substantially parallel to the planar surface of the larger buckle 12. To connect the smaller buckle 14 and the larger buckle 12, the smaller buckle 14 is passed through the opening 16 of the larger buckle 12 and then the smaller buckle 14 is placed in the second orientation so that it cannot pass back through the opening 16. To disconnect the smaller buckle 14 from the larger buckle 12, the smaller buckle 14 is placed in the second orientation and passed back through the opening 16 of the larger buckle 12.

A buckle cover keeper 30 is disposed around the larger buckle 12 and is structured to secure the smaller buckle 14 against the larger buckle 12 when the smaller buckle 14 and the larger buckle 12 are connected. The buckle cover keeper 30 and connection of the smaller buckle 14 and larger buckle 12 will be described in more detail herein.

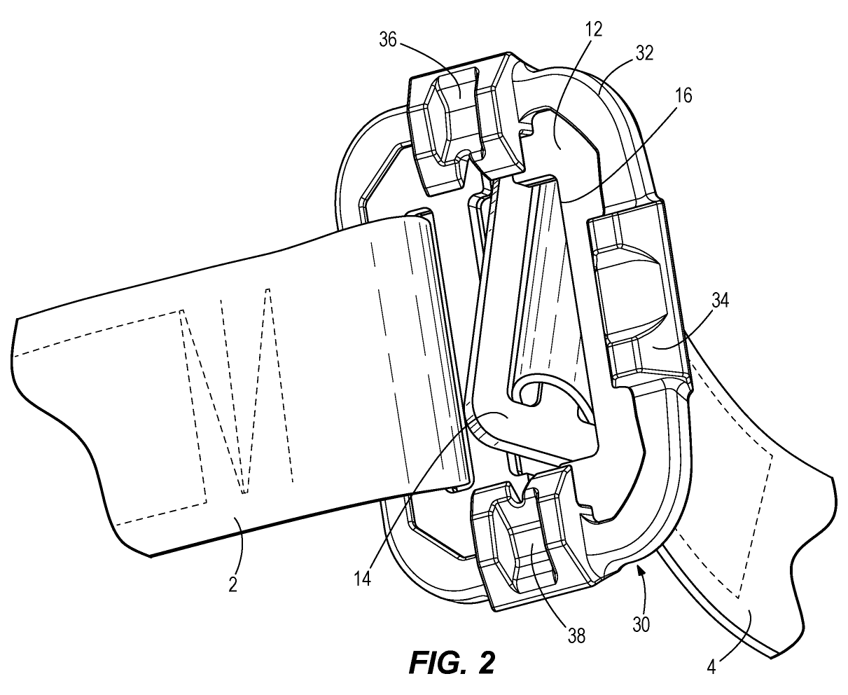

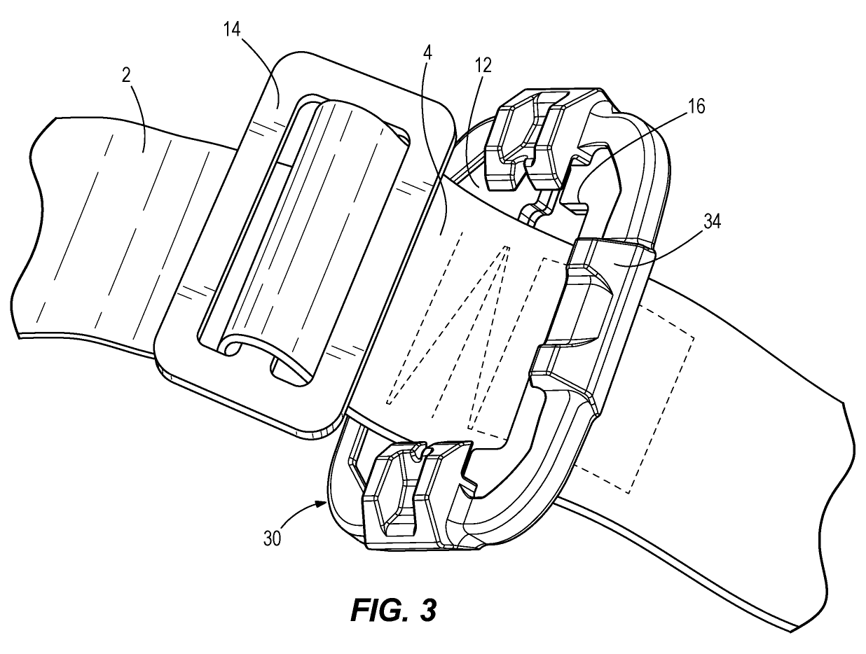

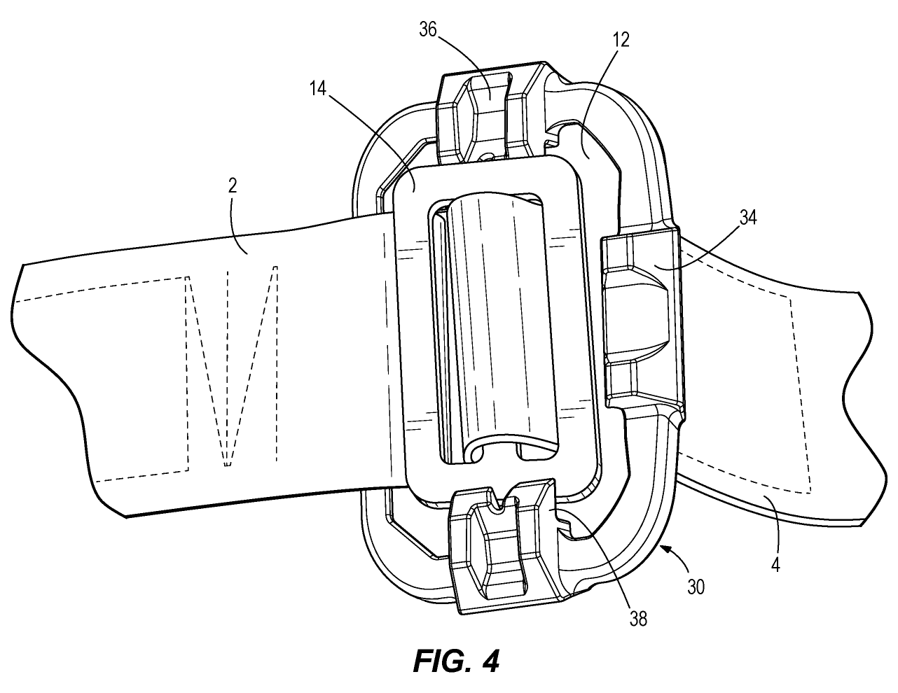

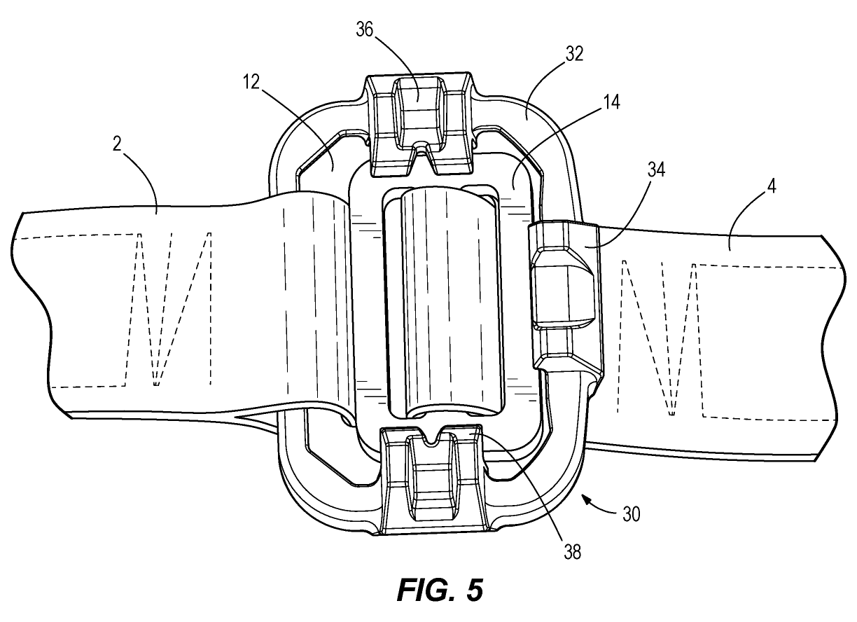

FIG. 2 is an image of the pass through buckle 10 in the process of being connected in accordance with an example embodiment of the disclosed concept. FIG. 3 is an image of the pass through buckle 10 further in the process of being connected in accordance with an example embodiment of the disclosed concept. FIG. 4 is an image of the pass through buckle 10 in the process of being secured with the buckle cover keeper 30 in accordance with an example embodiment of the disclosed concept. FIG. 5 is an image of the pass through buckle 10 secured with the buckle cover keeper 30 in accordance with an example embodiment of the disclosed concept.

The buckle cover keeper 30 includes a cover keeper body 32. The cover keeper body 32 has a shape that corresponds to an outer perimeter of the larger buckle 12. The cover keeper body 32 is slightly thicker than the larger buckle 12 and includes an upper surface 33 and a lower surface 35 that project inwardly a short distance and are structured to press against a top surface 37 and a bottom surface of the larger buckle 12 proximate the outer perimeter of the larger buckle 12. The cover keeper body 32 forms a groove 39 into which the outer perimeter of the larger buckle 12 is received. When the outer perimeter of the larger buckle 12 is received by the cover keeper body 32, the larger buckle 12 and the buckle cover keeper 30 are coupled and secured together. In some example embodiments, the larger buckle 12 and the buckle cover keeper 30 should be coupled and secured together before the first portion of webbing 2 is coupled to the larger buckle 12, as the first portion of webbing 2 will prevent the buckle cover keeper 30 from being coupled or uncoupled from the larger buckle 12. That is, the buckle cover keeper 30 may be considered unable to be removed once the buckle cover keeper 30 and the first portion of webbing 2 are both coupled to the larger buckle 12.

The buckle cover keeper 30 further includes a first short side tab 36, a second short side tab 38, and a long side tab 34. In the illustrated embodiment, the buckle cover keeper 30 has three tabs. In other embodiments, the buckle cover keeper 30 may have fewer or more tabs. The first short side tab 36 is structured to be disposed on one of the short sides of the rectangular shape of the larger buckle 12. The second short side tab 38 is structured to be disposed on the opposite short side of the rectangular shape of the larger buckle 12. The first and second short side tabs 36, 38 are coupled to the cover keeper body 32 and extend inwardly toward a center of the larger buckle 12 adjacent to the top surface 37 of the larger buckle 12 a first distance 41 and then extend inwardly an additional second distance 42 spaced apart from the top surface 37 of the larger buckle 12. Along the first distance 41, the first and second short side tabs 36, 38 are pressed against the top surface 37 of the larger buckle 12. Along the second distance 42, the first and second short side tabs 36, 38 are spaced from the top surface 37 of the larger buckle 12 a distance that is slightly smaller than a thickness of the smaller buckle 14. The first and second short side tabs 36, 38 cooperate with the top surface 37 of the larger buckle 12 to create slots to receive short side edges of the smaller buckle 14.

The long slide tab 34 is disposed on one of the long sides of the rectangular shape of the larger buckle 12. The long side tab 34 is coupled to the cover keeper body 32 and extends inwardly toward a center of the larger buckle 12 adjacent to the top surface 37 of the larger buckle 12 a first distance 43, and then extends inwardly an additional second distance 44 spaced apart from the top surface of the larger buckle 12. Along the first distance 43, the long side tab 34 is pressed against the top surface 37 of the larger buckle 12. Along the second distance 44, the long side tab 34 is spaced apart from the top surface 37 of the larger buckle 12 a distance that is slightly smaller than a thickness of the smaller buckle 14. The long side tab 34 cooperates with the top surface 37 of the larger buckle 12 to create a slot to receive a long side edge of the smaller buckle 12.

As shown in FIGS. 2 and 3, the smaller buckle 14 may be placed in the first orientation such that it is angled with respect to the larger buckle 12 and then passed through the opening 16 of the larger buckle 12. As shown in FIG. 4, the smaller buckle 14 is in the process of being placed in the second orientation where its planar surface is parallel to the planar surface of the larger buckle 12. Additionally, the buckle cover keeper 30 is structured to secure the smaller buckle 14 against the larger buckle 12. As the smaller buckle 14 is placed in the second orientation, the short side edges of the smaller buckle 14 are placed in the areas formed by the first and second short side tabs 36, 38, and the long side edge of the smaller buckle 14 is placed in the area formed by the long side tab 34. Once the smaller buckle 14 is placed in the areas formed by the tabs, the first and second short side tabs 36, 38 and the long side tab 34 hold and secure the smaller buckle 14 against the top surface 37 of the larger buckle 12, as is shown for example in FIG. 5.

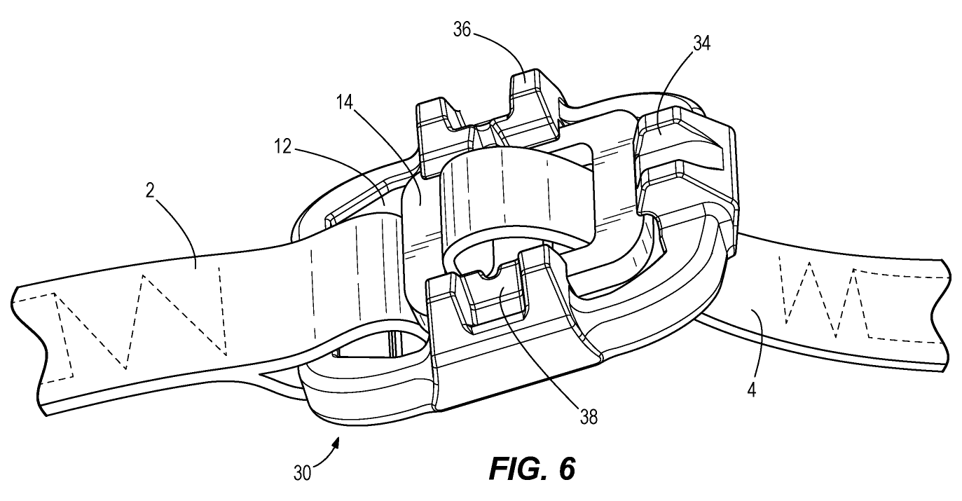

Without the buckle cover keeper 30 securing the smaller buckle 14 against the larger buckle 12, movement of the first and second portions of webbing 2, 4, could cause the smaller buckle 14 to move and potentially disconnect from the larger buckle 12. For example, FIG. 6 is an image of the buckle cover keeper 30 securing the smaller buckle 14 against the larger buckle 12. In FIG. 6, the first and second portions of webbing 2, 4 are being pressed toward each other. Such movement could cause the smaller buckle 14 to move away from the larger buckle 12. However, as shown in FIG. 6, the smaller buckle 14 is secured against the top surface 37 of the larger buckle 12 by the buckle cover keeper 30.

In some example embodiments, the smaller and larger buckles 12,14 are composed of metallic material. In some example embodiments, the buckle cover keeper 30 is composed of a flexible elastomeric material.

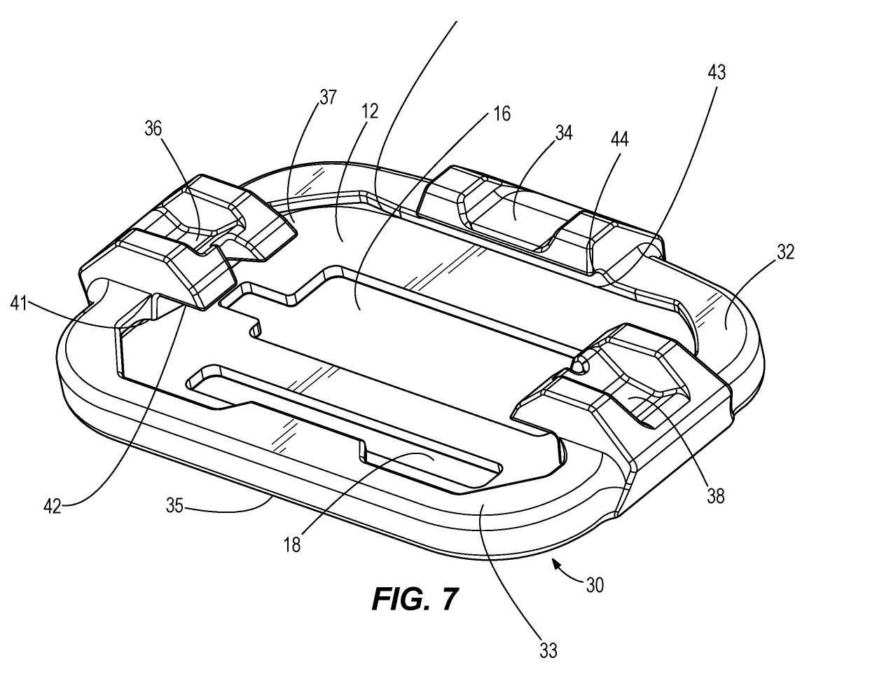

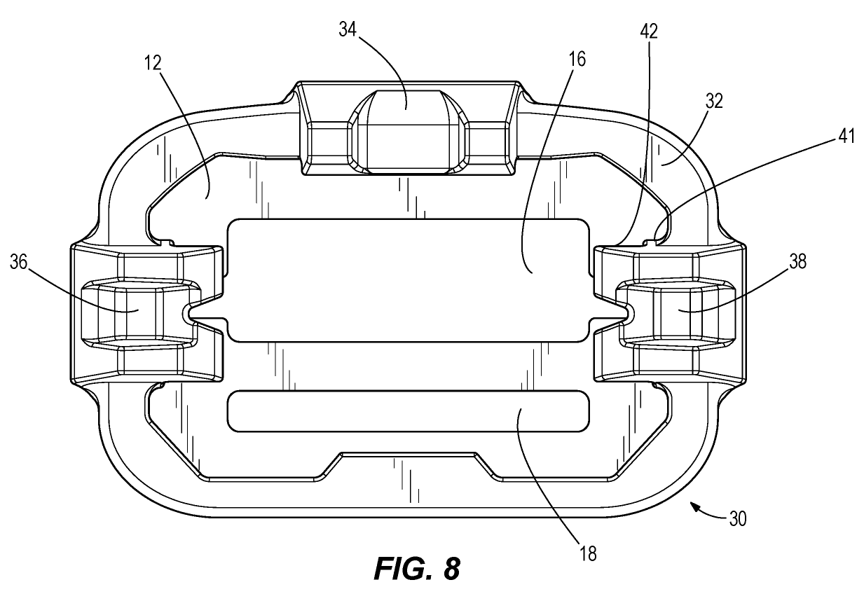

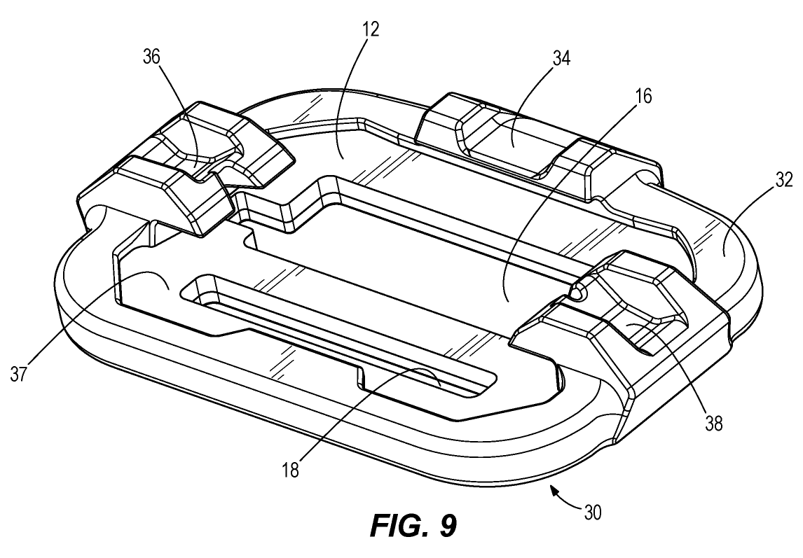

FIGS. 7, 8, and 9 are images of the buckle cover keeper 30 and larger buckle 12 in accordance with example embodiments of the disclosed concept. In some example embodiments, such as shown in FIGS. 7 and 8, the buckle cover keeper 30 is molded and then attached to the larger buckle 12. In some example embodiments, such as shown in FIG. 9, the buckle cover keeper 30 is overmolded on the larger buckle 12. The buckle cover keeper 30 overmolded on the larger buckle 12 provides the same functionality of securing the smaller buckle 14 against the larger buckle 12. Overmolding the buckle cover keeper 30 on the larger buckle 12 permanently bonds the buckle cover keeper 30 to the larger buckle 12 and thus provides additional protection against accidental removal of the buckle cover keeper 30 from the larger buckle 12. In some example embodiments, the buckle cover keeper 30 is molded as a single piece of material.

In some example embodiments, the tabs are angled slightly toward the top surface 37 of the larger buckle 12 across the second distance 42, 44. The angled surface assists with the ability of the tabs to press the smaller buckle 14 against the top surface 37 of the larger buckle 12.

In addition to securing the smaller buckle 14 to the larger buckle 12 to prevent loosening or disconnection, the buckle cover keeper 30 in some example embodiments may provide additional functions of preventing clinking between the larger buckle 12 and the smaller buckle 14. The buckle cover keeper 30 may also, in some example embodiments, provide electrical insulation from the larger and/or smaller buckles 12, 14.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A buckle cover keeper for a pass through buckle including a larger buckle and a smaller buckle structured to be releasably coupled together, the buckle cover keeper comprising:
a cover keeper body having a shape corresponding to an outer perimeter of the larger buckle, the cover keeper body being structured to couple to the larger buckle; and
at least one tab coupled to the cover keeper body and extending inwardly from the cover keeper body,
wherein the at least one tab is structured to create an area between the at least one tab and a top surface of the larger buckle when the cover keeper body is coupled to the larger buckle, and
wherein the area is structured to receive an outer edge of the smaller buckle when the smaller buckle is coupled to the larger buckle.

2. The buckle cover keeper of claim 1, wherein the at least one tab is structured to press the smaller buckle against the top surface of the larger buckle when the smaller buckle is coupled to the larger buckle.

3. The buckle cover keeper of claim 1, wherein the cover keeper body and the at least one tab are molded from a flexible elastomeric material.

4. The buckle cover keeper of claim 1, wherein the cover keeper body and the at least one tab are formed as a single piece of material.

5. The buckle cover keeper of claim 1, wherein the at least one tab includes a first tab disposed on a first side of the cover keeper body, a second tab disposed on a second side of the cover keeper body, and a third tab disposed on a third side of the cover keeper body.

6. The buckle cover keeper of claim 5, wherein the cover keeper body is rectangular, wherein the first side and the second side of the cover keeper body are short sides of the cover keeper body, and wherein the third side of the cover keeper body is a long side of the cover keeper body.

7. The buckle cover keeper of claim 1, wherein the buckle cover keeper is overmolded on the larger buckle.

8. A safety harness comprising:
a first portion of webbing;
a second portion of webbing;
a pass through buckle including a larger buckle coupled to the first portion of webbing and a smaller buckle coupled to the second portion of webbing, wherein the larger buckle and the smaller buckle are structured to be releasably coupled together; and
a buckle cover keeper comprising:
a cover keeper body having a shape corresponding to an outer perimeter of the larger buckle, the cover keeper body being structured to be coupled to the larger buckle; and
at least one tab coupled to the cover keeper body and extending inwardly from the cover keeper body,
wherein the at least one tab is structured to create an area between the at least one tab and a top surface of the larger buckle when the cover keeper body is coupled to the larger buckle, and
wherein the area is structured to receive an outer edge of the smaller buckle when the smaller buckle is coupled to the larger buckle.

9. The safety harness of claim 8, wherein the cover keeper body and the at least one tab are molded from a flexible elastomeric material.

10. The safety harness of claim 8, wherein the buckle cover keeper is overmolded on the larger buckle.

11. The safety harness of claim 8, wherein the at least one tab presses the smaller buckle against the top surface of the larger buckle when the smaller buckle is coupled to the larger buckle.

12. The safety harness of claim 8, wherein the at least one tab includes a first tab disposed on a first side of the cover keeper body, a second tab disposed on a second side of the cover keeper body, and a third tab disposed on a third side of the cover keeper body.

13. The safety harness of claim 8, wherein the at least one tab extends inwardly for a first distance and additionally extends inwardly for a second distance, wherein, along the first distance, the at least one tab is adjacent to the top surface of the larger buckle, and wherein, along the second distance, the at least one tab is spaced from the top surface to define the area.

14. The safety harness of claim 8, wherein the area has a thickness that is smaller than the thickness of the smaller buckle.

15. A safety harness comprising:
a first portion of webbing;
a second portion of webbing;
a pass through buckle including a larger buckle coupled to the first portion of webbing and a smaller buckle coupled to the second portion of webbing, wherein the larger buckle and the smaller buckle are structured to be releasably coupled together; and
a buckle cover keeper comprising:
a cover keeper body having a shape corresponding to an outer perimeter of the larger buckle, the cover keeper body having an upper surface and a lower surface defining a groove therebetween that receives the outer perimeter of the larger buckle; and
at least one tab coupled to the cover keeper body and extending inwardly from the cover keeper body.

16. The safety harness of claim 15, wherein the at least one tab extends inwardly for a first distance and additionally extends inwardly for a second distance, and wherein, along the first distance, the at least one tab is adjacent to a top surface of the larger buckle.

17. The safety harness of claim 16, wherein, along the second distance, the at least one tab is spaced from the larger buckle to define a slot.

18. The safety harness of claim 17, wherein a thickness of the slot is smaller than a thickness of the smaller buckle.

19. The safety harness of claim 15, wherein the at least one tab includes a first tab disposed on a first side of the cover keeper body, a second tab disposed on a second side of the cover keeper body, and a third tab disposed on a third side of the cover keeper body.

20. The safety harness of claim 15, wherein the buckle cover keeper is overmolded on the larger buckle.
